(19) United States
(12) Patent Application Publication
(10) Pub. No.: US 2009/0265117 A1
(43) Pub. Date: Oct. 22, 2009

(54) System and method for automated collection and reporting of greenhouse gas emission reductions

(76) Inventor: Jay James Castino, Bend, OR (US)

Correspondence Address: Jay James Castino, 1560 NE 1st ST. Suite #14, Bend, OR, 97701, US

(21) Appl. No.: 12/386,250

(22) Filed: Apr. 16, 2009

Related U.S. Application Data
(60) Provisional application No. 61/124,846, filed on Apr. 21, 2008.

(51) Int. Cl. G01N 31/00

(52) U.S. Cl. 702/24

(57) ABSTRACT

A system and method for automated collection and reporting of data indicative of greenhouse gas emissions reductions (GHGER) and GHGER is disclosed. Improvement upon the known process of collecting and reporting data indicative of GHGER for use in proposing verification, by a jurisdiction, of said data as GHGER and submitting GHGER for acceptance, by a jurisdiction, to an accounting registry, is combined using a computer database software application (CDSA).

### CROSS-REFERENCE TO RELATED APPLICATIONS

This application claims the benefit under 35 U.S.C. .sctn. 119(e) of U.S. Patent Application No. 61/124,846, filed on Apr. 21, 2008. The contents of all of this application are explicitly incorporated by reference herein in its entirety.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention is in the technical field of greenhouse gas emission reductions (GHGER), also identified using other names such as carbon credits, verified emission reductions, certified emissions reductions. GHGER allow those accounting for their excessive greenhouse gas emissions (GHG) an opportunity to offset or reduce total GHG emittance, by virtue of GHGER acquisition. A GHGER is defined within the context of the present invention as conversion of a volatile gas, such as methane, to a non-volatile and less environmentally harmful gas, such as carbon dioxide, via stoichiometric combustion.

More particularly, the present invention is in the technical field of Agricultural, Coal Mine, and Landfill Gas methane destruction GHGER projects and Ozone Depleting Substance GHGER projects.

More particularly, the present invention is in the technical field of collection and reporting data indicative of GHGER for use in proposing verification, by a jurisdiction, of said data as GHGER and submitting GHGER for acceptance, by a jurisdiction, to an accounting registry.

The present invention overcomes many problems existing in the prior art. This invention addresses the need for an automated system applied to combining the known processes of prior art such as: collecting and reporting data indicative of GHGER for use in proposing verification, by a jurisdiction, of said data as GHGER and submitting GHGER for acceptance, by a jurisdiction, to an accounting registry.

Known processes of prior art are mostly quantified by manual measurement, recording, and transposition. There is a great deal of error associated with manual means of collecting and reporting data indicative of GHGER. Questionable quality and validity of the GHGER is one result of the error introduced with manual means of collecting and reporting said data. Manual means of measurement and recording data indicative of GHGER can be exposed to tampering and manipulation. Consequently, downstream utility of said could be heavily discounted or dismissed, especially when attempting to verify and submit said data as GHGER for acceptance to an accounting registry, such as the Chicago Climate Exchange or the California Climate Action Reserve.

### BRIEF SUMMARY OF THE INVENTION

New, useful, and non-obvious improvement upon the known process of collecting and reporting data indicative of GHGER for use in proposing verification, by a jurisdiction, of said data as GHGER and submitting GHGER for acceptance, by a jurisdiction, to an accounting registry. Known process: collecting and reporting data indicative of GHGER. Useful, but not new improvement of the present invention: automated method for collecting and reporting data indicative of GHGER. Known process: proposing verification, by a jurisdiction, of data as GHGER. Useful and new, but obvious improvement of the present invention: automated method for proposing verification, by a jurisdiction, of data as GHGER. Known process: submitting GHGER for acceptance, by a jurisdiction, to an accounting registry. Useful and new, but obvious improvement of the present invention: automated method for submitting GHGER for acceptance, by a jurisdiction, to an accounting registry.

Non-Obviousness of the present invention: method of combining the improvements above, by virtue of a computer database software application (CDSA), and removing human interaction and manual measurement, recording and transposition of the data indicative of GHGER. Also, limiting human interaction with the invention to observation of the automated data created by the invention and acknowledgement of the GHGER. Advantages of the invention include: no manual measurement, recording, and/or reporting of the data indicative of GHGER, eliminating the possibility of tampering or manipulation of data, and implicit traceability of data which is also tamper evident. These advantages have benefits over the prior art which include: removing sources of error in the measurement, recording, and/or reporting of the data indicative of GHGER, increased quality of data indicative of GHGER, improved credibility and consistency of submitted data indicative of GHGER and subsequent GHGER, and streamlining of the known processes stated in the prior art.

### BRIEF DESCRIPTION OF THE SEVERAL VIEWS OF THE DRAWING

FIG. 1 is a process schematic of the present invention.

### DETAILED DESCRIPTION OF THE INVENTION

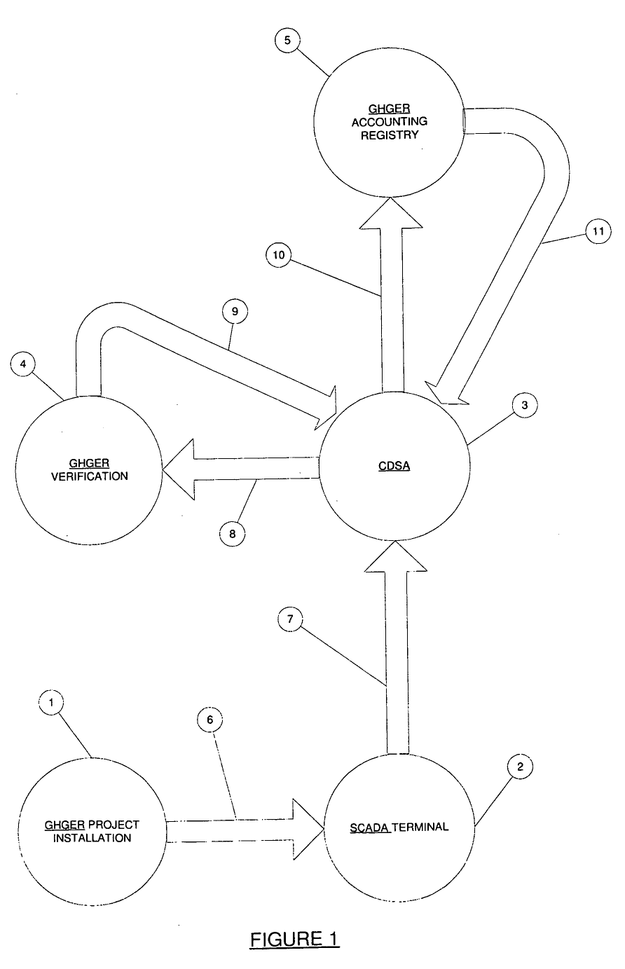

Referring now to the invention in more detail, in FIG. 1 there is shown a schematic illustration of the invention's system. It consists of a GHGER project installation 1, supervisory control and data acquisition (SCADA) terminal 2, CDSA 3, a jurisdiction for GHGER verification 4, and a jurisdiction with GHG accounting registry 5.

GHGER project installation 1 is a GHGER project embodied in the form of an Agricultural, Coal Mine, or Landfill Gas methane destruction GHGER project, or Ozone Depleting Substance GHGER project, or any plurality of the same.

SCADA terminal 2 is a data acquisition device. Data is acquired or collected via instrumentation fitted to GHGER project installation 1, such as a thermocouple and/or differential pressure transducer, which is the first record indicative of GHGER. The SCADA terminal historically identifies and logs each record indicative of GHGER. This historically identified log created with the SCADA terminal is periodically transmitted or reported to the CDSA 3 via process step 7. Criteria which establishes data indicative of GHGER, acquired or collected via instrumentation fitted to GHGER project installation 1, is usually created and documented by a jurisdiction with GHG accounting registry 5. Criteria which establishes data indicative of GHGER may be temperature measured within the methane control device (a combustion flare) of the GHGER project installation 1, which verifies conversion of methane to carbon dioxide, a less harmful GHG with less global warming potential. Another criteria which establishes data indicative of GHGER may be differential pressure measured from an orifice plate flowmeter at a GHGER project installation 1. Differential pressure measurement, from an orifice plate flowmeter installed within a pipeline at a GHGER project installation 1, verifies and is used to calculate flow, within said pipeline, of gas which terminates at a methane control device. Another criteria which establishes data indicative of GHGER may be measuring methane concentration of a gas within a pipeline installed at a GHGER project installation 1. Measuring methane concentration, of a gas within a pipeline installed at a GHGER project installation 1, verifies how much methane is converted, at the methane control device, to carbon dioxide, a less harmful GHG with less global warming potential. Hence, the known process of GHGER.

CDSA 3 is a computer database software application. It resides within a computer's data volume. SCADA terminal 2 reports its collected data indicative of GHGER to the CDSA. The computer's data volume stores said collected data indicative of GHGER, reported or transmitted to the CDSA 3. Also, end users of the CDSA associated with the invention's system may input data directly to the CDSA or view data directly from the CDSA. User input is limited to preparation, transmittal, and receipt of notifications and acknowledgements initiated by other end users, the CDSA itself, SCADA terminal 2, or indirectly from GHGER project installation 1 through SCADA terminal 2. End users associated with the system, such as the jurisdiction for GHGER verification 4 or jurisdiction with GHG accounting registry 5, interact with the system via below described process steps 8, 9, 10, 11. A designated administrator of the CDSA is an implicity specified end user associated with the invention's system whom may also interact with the system via below described process steps 8, 9, 10, 11. An example of the designated administrator of the CDSA may be the party or parties associated with ownership of the invention's system, but not necessarily. The computer's data volume stores all said end user input related to the present invention via the CDSA 3.

A jurisdiction for GHGER verification 4 is usually an entity approved by GHG accounting registry 5. Data indicative of GHGER, transmitted via process step 8, is reviewed and/or audited by said entity against GHGER project installation 1's eligibility criteria and protocol requirement, established by a jurisdiction with GHG accounting registry 5, for recording and reporting data indicative of GHGER. Jurisdiction for GHGER verification approves data indicative of GHGER, proposed via process step 8, as GHGER via process step 9.

A jurisdiction with GHG accounting registry 5 is usually an entity established for a jurisdiction for GHGER verification 4 to submit GHGER via process step 10, and to accept GHGER to an accounting registry. Said accounting registry uniquely tracks each GHGER accepted to the registry. It provides a method of allowing transactions between buyers and sellers of GHGER to be uniquely accounted for. It prevents possible problems associated with transactions between by buyers and sellers of GHGER such as double-counting of GHGER or other problems not specified herewithin.

In more detail, when used, still referring to the invention of FIG. 1, SCADA terminal 2, a jurisdiction for GHGER verification 4, and a jurisdiction with GHG accounting registry 5 are connected in the system to CDSA 3 with process steps. SCADA terminal 2 is connected in the system to CDSA 3 with one process step 7. A jurisdiction for GHGER verification 4 is connected in the system to CDSA 3 with two process steps 8, 9. A jurisdiction with GHG accounting registry 5 is connected in the system to CDSA 3 with two process steps 10,11. GHGER project installation 1 is connected in the system to SCADA terminal 2 with a process step 6. Therefore, GHGER project installation 1 is also indirectly connected in the system to CDSA 3, by virtue of SCADA terminal 2 connected in the system to CDSA 3 with a process step 7.

There is a process step of collecting data indicative of GHGER 6 from GHGER project installation 1, by virtue of the SCADA terminal 2. There is a process step of reporting data indicative of GHGER 7 from the SCADA terminal 2 to the CDSA 3, by virtue of the SCADA terminal 2. There is a process step of proposing data indicative of GHGER for verification 8 by a jurisdiction as GHGER, by virtue of end user input to the CDSA 3. There is a process step of approving data indicative of GHGER as GHGER 9, by virtue of notification by the GHGER verification jurisdiction via the CDSA3. There is a process step of submitting GHGER for acceptance 10 by a jurisdiction to a GHGER accounting registry 5, by virtue of end user input to the CDSA 3. Finally, there is a process step of acknowledging submitted GHGER as accepted to an accounting registry 11, by virtue of notification by the GHGER accounting registry jurisdiction 5 via the CDSA 3.

In further detail, still referring to the invention of FIG. 1, process steps 7, 8, 9, 10, 11 are most desirably interfaced to CDSA 3 by virtue of an internet connection. Therefore end users, such as the jurisdiction for GHGER verification 4, jurisdiction with GHG accounting registry 5, or the designated administrator of the CDSA 3 is most desirably interfaced to CDSA 3 with a device capable of receiving and transmitting with an internet connection in order to interface with CDSA 3, such as with a personal computer. SCADA terminal 2 is also most desirably interfaced to CDSA 3 as a device capable of transmitting with an internet connection. A method useful for receiving and transmitting with an internet connection in order to interface with CDSA 3 could be via electronic form input served from the CDSA 3. A method useful for transmitting with an internet connection in order to interface with CDSA 3 could be via email or FTP protocol to the data volume of CDSA.

The advantages of the present invention include, without limitation,
1. Non-Obviousness
   a. Method of combining the improvements above, by virtue of a computer database software application (CDSA), and removing human interaction and manual measurement, recording and transpostion of the data indicative of GHGER.
   b. Human interaction with the invention is limited to observation of the automated data created by the invention and acknowledgement of the GHGER.
2. Features
   a. No manual measurement, recording, and/or reporting of the data indicative of GHGER.
   b. Eliminate possibility of tampering or manipulation of data.
   c. Implicit traceability of data and tamper evident.
3. Benefits
   a. Remove sources of error in the measurement, recording, and/or reporting of the data indicative of GHGER.
   b. Quality of data increases.
   c. Credibility and consistancy of GHGER improves
   d. Streamline the known processes stated in the prior art.

In broad embodiment, the present invention is a system and method for automated collection and reporting of data indicative of GHGER and GHGER. While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

The invention claimed is:

1. A computer-implemented system for collecting, recording, and reporting data indicative of the first record of a greenhouse gas emission reduction (GHGER).

2. The system of claim 1, referred to FIG. 1, consisting of a GHGER project installation 1, supervisory control and data acquisition (SCADA) terminal 2, CDSA 3, a jurisdiction for GHGER verification 4, and a jurisdiction with GHG accounting registry 5.

3. The system of claim 1, with system components of claim 2, referred to FIG. 1, connected with process steps 6,7,8,9,10,11, described in the present invention's above specification.

4. A computer-implemented method for collecting, recording, and reporting data indicative of the first record of a greenhouse gas emission reduction (GHGER).

5. The method of claim 4, referred to FIG. 1, consisting of a GHGER project installation 1, supervisory control and data acquisition (SCADA) terminal 2, CDSA 3, a jurisdiction for GHGER verification 4, and a jurisdiction with GHG accounting registry 5.

6. The method of claim 4, with system components of claim 2, referred to FIG. 1, connected with process steps 6,7,8,9,10,11, described in the present invention's above specification.
